(19) United States
(12) Patent Application Publication
(10) Pub. No.: US 2003/0096934 A1
(43) Pub. Date: May 22, 2003

(54) Oligomeric silasesquioxanes and a process for preparing oligomeric silasesquioxanes

(75) Inventors: Carsten Jost, Marl (DE); Hendrikus Cornelis Louis Abbenhuis, Nuenen (NL); Rutger Anthoney Van Santen, Eindhoven (NL); Maria Danuta Skowronska-Ptasinska, Eindhoven (NL); Adolf Kuehnle, Marl (DE); Mark Duda, Ludwigshafen (DE)

Correspondence Address: OBLON SPIVAK MCCLELLAND MAIER & NEUSTADT, FOURTH FLOOR, 1755 JEFFERSON DAVIS HIGHWAY, ARLINGTON, VA, 22202, US

(73) Assignee: CREAVIS GESELLSCHAFT F. TECHN. U. INNOVATION MBH, Marl (DE)

(21) Appl. No.: 10/210,082

(22) Filed: Aug. 2, 2002

Related U.S. Application Data
(63) Continuation of application No. 10/005,108, filed on Dec. 7, 2001.

(30) Foreign Application Priority Data
Dec. 7, 2000 (DE) 10060776.4

(51) Int. Cl. C08G 77/00

(52) U.S. Cl. 528/10

(57) ABSTRACT

Oligomeric silasesquioxanes having the formula R₆Si₆O₉ wherein R is alkyl, cycloalkyl other than cyclohexyl, alkenyl, cycloalkenyl, alkynyl, cycloalkynyl, aryl, and/or heteroaryl, and the structure I; processes for preparing oligomeric silasesquioxanes of formula R₆Si₆O₉ wherein R is alkyl, cycloalkyl, alkenyl, cycloalkenyl, alkynyl, cycloalkynyl, aryl, and/or heteroaryl; processes of using such oligomeric silasesquioxanes; and products obtained thereby.

### BACKGROUND OF THE INVENTION

1. Field of the Invention

The invention relates to oligomeric silasesquioxanes having the formula R₆Si₆O₉ (R=alkyl, cycloalkyl (c-C₃H₅, c-C₄H₇, c-C₅H₉, c-C₇H₁₃, c-C₈H₁₅, c-C₉H₁₇, c-C₁₀H₁₉,), alkenyl, cycloalkenyl, alkynyl, cycloalkynyl, aryl, and/or heteroaryl) and the structure I and also to a process for preparing oligomeric silasesquioxanes having the formula R₆Si₆O₉ (R=alkyl, cycloalkyl, alkenyl, cycloalkenyl, alkynyl, cycloalkynyl, aryl, and/or heteroaryl) and the structure I and also to their use for the synthesis of incompletely condensed silasesquioxanes, of catalysts and their starting compounds and also of polymers.

2. Description of the Background

Oligomeric silasesquioxanes can be used as starting materials for the synthesis of polymers having a wide range of applications. These polymers can be used, for example, in the form of coating materials or as fillers. Since the polysilasesquioxanes comprise both organic and inorganic constituents, they have an improved thermal stability compared to purely organic compounds.

In U.S. Pat. No. 5,484,867, Lichtenhan et al. describe the use of oligomeric silasesquioxanes having a reactive corner group, while in U.S. Pat. No. 5,412,053 they describe the use of bifunctional oligomeric silasesquioxanes for the synthesis of polysilasesquioxanes. Since the basic structure of the polymer has been preformed in the oligomeric silasesquioxane unit, these processes allow many disadvantages of direct polymerization of the silane monomers, e.g. the formation of undesirable by-products, to be avoided. Metal-containing oligomeric silasesquioxanes have recently been gaining increasing importance because of their possible use as catalysts (Chem. Eur. J 2000, 6, 25-32).

The synthesis of oligomeric silasesquioxanes is generally carried out by hydrolytic condensation of trifunctional RSiY₃ precursors, where R is a hydrocarbon radical and Y is a hydrolyzable group such as chloride, alkoxide or siloxide (J. Am. Chem. Soc. 1989, 111, 1741-1748; Organometallics 1991, 10, 2526-2528), This reaction usually produces mixtures of completely and incompletely condensed oligomeric silasesquioxanes. An important, completely condensed, oligomeric silasesquioxane is the compound R₆Si₆O₉ (I).

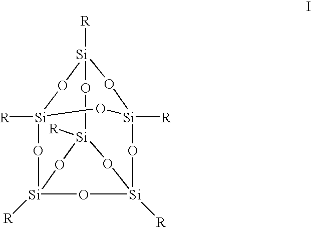

This compound of the structure I has hitherto been prepared in an isolatable yield only for R=cyclohexyl. In this case, the synthesis of the compound having the structure I, which is frequently also described by its empirical formula (c-C₆H₁₁SiO_{1.5})₆ gives an unsatisfactory yield of 7% after an extraordinarily long reaction time of over one year (J. Am. Chem. Soc. 1989, 111, 1741-1748). Compounds of the structure I containing other hydrocarbon radicals R are not known in isolated form.

The compound of the structure I in which R=c-C₆H₁₁ can be obtained by a reaction in which the monomer concentration employed is 0.2 mol/l, which is generally customary for the synthesis of oligomeric silasesquioxanes and has hitherto not been exceeded in order to avoid direct polycondensation to form polysilasesquioxanes (Top. Curr. Chem. 1982, 102, 199-236).

Compounds of the structure I in which R=c-C₆H₁₁ are of great importance because, inter alia, they can be reacted in the presence of basic catalysts with R¹Si(OMe)₃ (R¹=vinyl) to give functionalized, incompletely condensed silasesquioxanes of the structure II, e.g. R₆R¹Si₇O₉(OH)₃ where R=c-C₆H₁₁ and R¹=vinyl (Chem. Commun. 1999, 2153-2154, Polym. Mater. Sci. Eng. 2000, 82, 301-302).

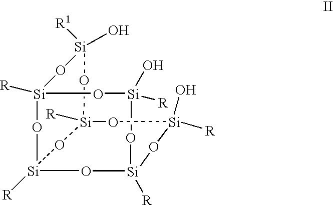

However, only few silasesquioxanes which differ in terms of their hydrocarbon radicals R and R¹ have up to now been able to be prepared by this route.

### SUMMARY OF THE INVENTION

It is therefore an object of the present invention to provide hitherto unobtainable oligomeric silasesquioxanes having the formula R₆Si₆O₉ and the structure I whose radicals R are different from cyclohexyl, and also an efficient process far preparing oligomeric silasesquioxanes having the formula R₆Si₆O₉ (R=alkyl, cycloalkyl, alkenyl, cycloalkenyl, alkynyl, cycloalkynyl, aryl, and/or heteroaryl) and the structure I.

### DETAILED DESCRIPTION OF THE INVENTION

It has surprisingly been found that hitherto unobtainable silasesquioxanes having the formula R₆Si₆O₉ and the structure I can not only be prepared with a variety of radicals (R=alkyl, cycloalkyl (c-C₃H₅, c-C₄H₇, c-C₅H₉, c-C₇H₁₃, c-C₈H₁₅, c-C₉H₁₇, c-C₁₀H₁₉), alkenyl, cycloalkenyl, alkynyl, cycloalkynyl, aryl, and/or heteroaryl), but that the silasesquioxanes having the formula R₆Si₆O₉ (R=alkyl, cycloalkyl, alkenyl, cycloalkenyl, alkynyl, cycloalkynyl, aryl, and/or heteroaryl) and the structure I can also be synthesized in significantly improved yields compared to processes known hitherto for preparing (cyclohexyl)₆Si₆O₉ (J. Am. Chem. Soc. 1989, 111, 1741-1748; Organometallics 1991, 10, 2526-2528) in a greatly shortened reaction time when the concentration of the monomer is greater than 0.2 mol/l.

The present invention accordingly provides oligomeric silasesquioxanes having the formula R₆Si₆O₉ where R=alkyl, cycloalkyl other than cyclohexyl, alkenyl, cycloalkenyl, alkynyl, cycloalkynyl, aryl, and/or heteroaryl) and the structure I.

The present invention likewise provides a process for preparing oligomeric silasesquioxanes having the formula R₆Si₆O₉ where R=alkyl, cycloalkyl, alkenyl, cycloalkenyl, alkynyl, cycloalkynyl, aryl and/or heteroaryl and the structure I by condensation of monomers of the formula RSiX₃, where X can be a hydrolyzable group or a group capable of a condensation reaction, wherein the condensation is carried out in solution at a concentration of monomers of greater than 0.2 mol/l.

The present invention also provides for processes of using oligomeric silasesquioxanes, or using oligomeric silasesquioxanes prepared as described above, for the synthesis of catalysts, their starting compounds and also polymers.

The present invention likewise provides for processes of using oligomeric silasesquioxanes, or using oligomeric silasesquioxanes prepared as described above, for hydrolysis to form incompletely condensed silasesquioxanes.

The present invention provides previously unknown oligomeric silasesquioxanes which can serve as important starting materials for further conversion into functionalized, incompletely condensed silasesquioxanes and a variety of downstream products thereof. Compounds of the structure I were hitherto known only for R=cyclohexyl.

The process of the present invention has the advantage that silasesquioxanes having the empirical formula: R₆Si₆O₉ where R=alkyl, cycloalkyl, alkenyl, cycloalkenyl, alkynyl, cycloalkynyl, aryl and/or heteroaryl and the structure I can be synthesized in good yields after short reaction times. These compounds can be used for the preparation of incompletely condensed silasesquioxanes, of catalysts and their starting compounds and also of polymers.

It has hitherto been assumed that monomer concentrations above 0.2 mol/l favor the polycondensation to form polysilasesquioxanes and that for this reason relatively large amounts of polysilasesquioxanes are formed as by-products in addition to oligomeric silasesquioxanes. The relatively high concentrations used in the process of the invention do not lead to preferential formation of the incompletely condensed silasesquioxanes known from the literature (Organometallics 1991, 10, 2526-2528), but, in contrast; the completely condensed hexameric silasesquioxanes having the formula R₆Si₆O₉ and the structure I are obtained in good yield after a short reaction time. These have the advantage that they open up an easier route to incompletely condensed silasesquioxanes, to catalysts and their starting compounds and also to polymers.

One aspect of the present invention is therefore the provision of oligomeric silasesquioxanes having the formula R₆Si₆O₉ where R=alkyl, cycloalkyl other than cyclohexyl, alkenyl, cycloalkenyl, alkynyl, cycloalkynyl, aryl and/or heteroaryl and the structure I.

The radicals R in these oligomeric silasesquioxanes preferably include at least one methyl, ethyl, propyl, butyl, i-butyl, cyclopropyl, cyclobutyl, cyclopentyl, cycloheptyl, cyclooctanyl, cyclononanyl, cyclodecanyl, vinyl, propenyl, monounsaturated or polyunsaturated butenyl, cyclopropenyl, monounsaturated or polyunsaturated cyclobutenyl, monounsaturated or polyunsaturated cyclopentenyl, monounsaturated or polyunsaturated cyclohexenyl, monounsaturated or polyunsaturated cycloheptenyl, monounsaturated or polyunsaturated cyclooctenyl, ethynyl, propynyl, monounsaturated or polyunsaturated butynyl, benzyl and/or pyridyl group. (The term “polyunsaturated” as a prefix for butenyl, cyclobutenyl, cyclopentenyl, cyclohexenyl, cycloheptenyl, cyclooctenyl, and butynyl groups, is intended to represent one or more additional double or triple bonds up to the theoretical maximum including also aromatic systems.) These radicals R may each be either substituted or unsubstituted. There are no restrictions on groups which may be substituted. Substituted radicals R have, for example, a halogen atom such as chlorine or bromine in place of a hydrogen atom. There are no restrictions on groups which may be substituted.

The oligomeric silasesquioxane very particularly preferably has at least one cyclopentyl group and/or cyclohexyl group as radical R. The radicals R in the oligomeric silasesquioxanes may be identical or different. In the case of different radicals R^{a}, R^{b}, . . . , R^{f}, the empirical formula is, strictly speaking, R^{a}ₘR^{b}ₙR^{c}ₒR^{d}ₚR^{e}_{q}R^{f}ₛSi₆O₉ where m, n, o, p, q and s are each an integer less than or equal to 6, or 0, and m+n+o+p+q+s=6. In the case of identical radicals R, i.e. R^{a}=R^{b}=R^{C}=R^{d}=R^{e}=R^{f}, the empirical formula once again reduces to R₆Si₆O₉. The oligomeric silasesquioxanes of the invention particularly preferably have identical groups as radicals R.

The oligomeric silasesquioxanes of the invention and also other known silasesquioxanes can be prepared by means of the process of the invention. This process of the invention is suitable for preparing oligomeric silasesquioxanes having the formula R₆Si₆O₉ where R=alkyl, cycloalkyl, alkenyl, cycloalkenyl, alkynyl, cycloalkynyl, aryl and/or heteroaryl and the structure I by condensation of monomers of the formula RSiX₃, where X can be a hydrolyzable group or a group capable of a condensation reaction, in solution at a concentration of monomers of greater than 0.2 mol/l. The concentration of monomers in the solution is preferably greater than 0.4 mol/l and very particularly preferably from 0.5 mol/l to 2.5 mol/l.

The condensation reaction can be carried out in a manner known to those skilled in the art.

As monomers of the type RSiX₃, preference is given to using compounds in which the groups X include at least one group selected from among —OH, —ONa, —OK, —OR′, —OCOR′, —OSiR′₃, —Cl, —Br, —I and —NR′₂, where R′ is an organic radical or hydrogen. It is also possible to use compounds in which the groups X are identical, e.g. (methyl)SiCl₃ or (cyclohexyl)Si(OH)₃, and also compounds containing different groups as groups X, e.g. (methyl)SiCl₂(OH) or (cyclohexyl)Si(OR′)₂Cl, as monomers. Preference is given to using compounds of the type RSiX₃ in which all three groups X are identical as monomers.

As monomer, use is made of at least one compound of the type RSiX₃ in which the radical R is a methyl, ethyl, propyl, butyl, i-butyl, cyclopropyl, cyclobutyl, cyclopentyl, cycloheptyl, cyclooctanyl, cyclononanyl, cyclodecanyl, vinyl, propenyl, monounsaturated or polyunsaturated butenyl, cyclopropenyl, monounsaturated or polyunsaturated cyclobutenyl, monounsaturated or polyunsaturated cyclopentenyl, monounsaturated or polyunsaturated cyclohexenyl, monounsaturated or polyunsaturated cycloheptenyl, monounsaturated or polyunsaturated cyclooctenyl, ethynyl, propynyl, monounsaturated or polyunsaturated butynyl, benzyl or pyridyl group.

It may also be advantageous to use two or more different monomers, e.g. RSiCl₃ and RSi(OH)₃, in the solution. The condensation is preferably carried out in a solution comprising only one type of monomer.

The hydrolytic condensation is preferably carried out in the absence of catalysts. However, the use of catalysts can be advantageous for controlling or accelerating the reaction. The condensation process of the invention can therefore be carried out in the absence of a catalyst or in the presence of at least one acidic catalyst or basic catalyst. As basic catalyst, preference is given to using an organic or inorganic base. A very particularly preferred basic catalyst is a compound selected from among KOH, NaOH, (C₂H₅)₄NOH, C₆H₅CH₂(CH₃)₃NOH, (CH₃)₄NOH and (C₂H₅)₃N or a mixture of these compounds. As acidic catalyst, preference is given to using an organic or inorganic acid. A very particularly preferred acidic catalyst is a compound selected from among hydrochloric acid (HCl), ZnCl₂, AlCl₃, HClO₄, acetic acid (CH₃COOH); nitric acid (HNO₃) and sulfuric acid (H₂SO₄) or a mixture of these compounds.

The condensation is carried out in solution. As solvent, it is possible to use either a polar solvent or a nonpolar solvent. The condensation is particularly preferably carried out in a solution comprising as solvent at least one compound selected from among alcohols, ketones, aldehydes, ethers, acids, esters, anhydrides, alkanes, aromatics and nitrites and mixtures of two or more of these compounds. Particular preference is given to using alcohols, ethers, acetone, acetonitrile, benzene or toluene as solvent. It is of course also possible to use mixtures of solvents.

Depending on the type of monomers used, it may be necessary for water to be present during the condensation. This depends on whether or not the monomers contain hydroxyl groups. If the monomers are, for example, compounds of the formula RSi(OH)₃, the condensation can also be carried out without addition of water. If the monomers are, for example, compounds of the formula RSiCl₃, water needs to be present as a reactant to allow the condensation to occur (via the silanols formed as intermediates). The condensation is therefore preferably commenced in the presence of water. Preference is given to adding water, preferably in an amount of from 0.1 to 50% by weight, particularly preferably from 5 to 50% by weight, based on the monomer-containing solution, to the reaction mixture prior to commencement of the condensation. However, depending on the water content of the solvent, the traces of water present in the solvent can also be utilized.

The process of the invention or the condensation can be carried out at a temperature of from −20° C. to 300° C., preferably from 0° C. to 200° C. It may be advantageous to alter the temperature during the reaction. Thus, in particular, it can be advantageous to reduce the temperature toward the end of the reaction in order to isolate the product as completely as possible. The way in which the condensation reaction is carried out will be known per se to those skilled in the art.

The reaction can be carried out at atmospheric pressure, subatmospheric pressure or superatmospheric pressure. The reaction or condensation is preferably carried out at atmospheric pressure.

In a particularly preferred embodiment of the process of the invention, a solution of at least one monomer of the formula RSiX₃ in at least one solution is placed in a reaction vessel with superposed condenser. This solution is heated to boiling under reflux and water is carefully added to the boiling solution while stirring vigorously. The solution is slowly brought to room temperature by switching off the source of heat and is stirred further for at least 24 hours, preferably at least 168 hours. This gives a crude product comprising at least one oligomeric silasesquioxane of the formula R₆Si₆O₉ which, is filtered off from the solution and washed at least once with the solvent which was present in the solution. It may be advantageous to grind the filtered-off residue in a mortar, to disperse it again in a small amount of the solvent and subsequently to filter it off again. This procedure can be repeated until the filter residue has the desired purity.

To purify the residue further, in particular to separate incompletely condensed silasesquioxanes from the completely condensed silasesquioxanes of the formula R₆Si₆O₉, it can be advantageous to dry the filter residue and admix it with from three to ten times, preferably from four to seven times, its weight of pyridine. In contrast to the incompletely condensed silasesquioxanes, the completely condensed silasesquioxane is virtually insoluble in pyridine and can be filtered off. This procedure, too, can be repeated until the desired purity is obtained.

After purification by means of pyridine, it can be advantageous to recrystallize the completely condensed silasesquioxane. The recrystallization is preferably carried out using chloroform.

The oligomeric silasesquioxanes of the invention or the oligomeric silasesquioxanes prepared by the process of the invention and having the formula R₆Si₆O₉ (R=alkyl, cycloalkyl, alkenyl, cycloalkenyl, alkynyl, cycloalkynyl, aryl, and/or heteroaryl) and the structure I can be used in processes for preparing incompletely condensed silasesquioxanes. Examples of incompletely condensed silasesquioxanes are: compounds of the type R₇Si₇O₉(OH)₃ and R₆Si₆O₇(OH)₄. In these processes, the oligomeric silasesquioxanes having the formula R₆Si₆O₉ (R=alkyl, cycloalkyl, alkenyl, cycloalkenyl, alkynyl, cycloalkynyl, aryl, and/or heteroaryl) and the structure I can be reacted, for example, with Bu₄NOH and/or a compound of the formula R¹Si(OR²)₃, where R¹ is an alkyl group containing at least one unsaturated C—C double bond and R² is an alkyl group, preferably a methyl group.

These incompletely condensed silasesquioxanes can serve as starting compounds in processes for preparing polymers, e.g., by hydrolytic polycondensation, or as starting compounds for the preparation of catalysts, e.g., by reaction of the incompletely condensed silasesquioxanes with metal compounds to form metal-modified silasesquioxanes (metallasilasesquioxanes). Subsequent modification or replacement of the radicals R is of course also possible.

The incompletely condensed silasesquioxanes are particularly preferably modified by means of metals. Preference is given to modifying silasesquioxanes with metal compounds of the transition groups including the lanthanides and actinides and of main groups 3 and 4. In these processes, the incompletely condensed silasesquioxanes are reacted, for example, with metal alkoxides such as Ti(OBu^{t})₄. Examples of metal modified silasesquioxanes which can be obtained in this way are the titanasilasesquioxanes (C₅H₉)₆(CH₂CH)Si₇O₁₂Ti(OBu^{t}) and (C₇H₁₃)₆(CH₂CH)Si₇O₁₂Ti(OBu^{t}).

The following examples illustrate the invention without restricting its scope:

### EXAMPLE 1

### Preparation of an Oligomeric Silasesquioxane of the Formula (C₆H₁₁)₆Si₆O₉

100 ml of H₂O were carefully added while stirring to a solution of 100 g (460 mmol) of C₆H₁₁SiCl₃ in 400 ml of acetone, with the solution being maintained at the boiling point during the addition. The reaction mixture was stirred at room temperature for another 168 hours. The crude product was filtered off and washed with acetone. The filter residue was ground in a mortar and dispersed in 70 ml of acetone by stirring. After 1 hour, the solid was isolated by filtration and dried at 40° C. for 12 hours. The product mixture was admixed with five times its weight of pyridine and the suspension was stirred for 30 minutes. After filtration and washing with pyridine, the product was recrystallized from chloroform. This gave 15.4 g (19.0 mmol) of (C₆H₁₁)₆Si₆O₉. This corresponded to a yield of 24.9%.

### EXAMPLE 2

### Preparation of an Oligomeric Silasesquioxane of the Formula (C₅H₉)₆Si₆O₉

100 ml of H₂O are carefully added while stirring to a solution of 93 g (457 mmol) of C₅H₉SiCl₃ in 400 ml of acetone with the solution being maintained at the boiling point during the addition. The reaction mixture is stirred at room temperature for another 168 hours. The crude product is filtered off and washed with acetone. The filter residue is ground in a mortar and dispersed in 70 ml of acetone by stirring. After 1 hour, the solid is isolated by filtration and dried at 40° C. for 12 hours. The product mixture is admixed with five times its weight of pyridine and the suspension is stirred for 30 minutes. After filtration and washing with pyridine, the product is recrystallized from chloroform. This gives 11.6 g (16.0 mmol) of (C₅H₉)₆Si₆O₉. This corresponds to a yield of 21.0%.

### EXAMPLE 3

### Preparation of an Oligomeric Silasesquioxane of the Formula (C₇H₁₃)₆Si₆O₉

100 ml of H₂O are carefully added while stirring to a solution of 106 g (458 mmol) of C₇H₁₃SiCl₃ in 400 ml of acetone, with the solution being maintained at the boiling point during the addition. The reaction mixture is stirred at room temperature for another 168 hours. The crude product is filtered off and washed with acetone. The filter residue is ground in a mortar and dispersed in 70 ml of acetone by stirring. After 1 hour, the solid is isolated by filtration and dried at 40° C. for 12 hours. The product mixture is admixed with five times its weight of pyridine and the suspension is stirred for 30 minutes. After filtration and washing with pyridine, the product is recrystallized from chloroform. This gives 13.0 g (14.5 mmol) of (C₇H₁₃)₆Si₆O₉. This corresponds to a yield of 19.0%.

### EXAMPLE 4

### Preparation of Incompletely Condensed Silasesquioxanes Using a Compound of the Formula R₆Si₆O₉

A solution of 1.99 g (2.74 mmol) of (C₅H₉)₆Si₆O₉ in 10 ml of THF is admixed with 1.85 ml (2.77 mmol) of aqueous Bu₄NOH and stirred at 25° C. for 1 hour. The mixture is subsequently neutralized using 2M hydrochloric acid. The solvent is removed, the residue is dissolved in diethyl ether and the solution is dried over magnesium sulfate. Evaporation of the solvent gives (C₅H₉)₆Si₆O₇(OH)₄ in quantitative yield.

### EXAMPLE 5

### Preparation of Incompletely Condensed Silasesquioxanes Using a Compound of the Formula R₆Si₆O₉

1.85 ml (2.77 mmol) of an aqueous solution of Bu₄NOH are added to a solution of 1.99 g (2.74 mmol) of (C₅H₉)₆Si₆O₉ and 0.42 ml of (vinyl)Si(OMe)₃ in 10 ml of THF. The solution is stirred for 12 hours, the solvent is removed, the residue is dissolved in diethyl ether and the solution is dried over magnesium sulfate. Evaporation of the solvent gives (C₅M₉)₆(CH₂CH)Si₇O₉(OH)₃ in quantitative yield.

### EXAMPLE 6

### Preparation of Incompletely Condensed Silasesquioxanes Using a Compound of the Formula R₆Si₆O₉

A solution of 2.45 g (2.74 Mmol) of (C₇H₁₃)₆Si₆O₉ in 10 ml of THF is admixed with 1.85 ml (2.77 mmol) of aqueous Bu₄NOH and stirred at 25° C. for 1 hour. The mixture is subsequently neutralized using 2M hydrochloric acid. The solvent is removed, the residue is dissolved in diethyl ether and the solution is dried over magnesium sulfate. Evaporation of the solvent gives (C₇H₁₃)₆Si₆O₇(OH)₄ in quantitative yield.

### EXAMPLE 7

### Preparation of Incompletely Condensed Silasesquioxanes Using a Compound of the Formula R₆Si₆O₉

1.85 ml (2.77 mmol) of an aqueous solution of Bu₄NOH are added to a solution of 2.45 g (2.74 mmol) of (C₇H₁₃)₆Si₆O₉ and 0.42 ml of (vinyl)Si(OMe)₃ in 10 ml of THF. The solution is stirred for 12 hours, the solvent is removed, the residue is dissolved in diethyl ether and the solution is dried over magnesium sulfate. Evaporation of the solvent gives (C₇H₁₃)₆(CH₂CH)Si₇O₉(OH)₃ in quantitative yield.

### EXAMPLE 8

### Preparation of Titanium-Modified Silasesquioxanes Using Incompletely Condensed Silasesquioxanes

1 g (2.94 mmol) of Ti(OBu^{t})₄ is added to a solution of 2.3 g (2.76 mmol) of (C₅H₉)₆(CH₂CH)Si₇O₉(OH)₃ in 100 ml of toluene and the reaction mixture is stirred for 30 minutes. The solid is subsequently filtered off, dissolved in toluene and reprecipitated by means of acetonitrile. This gives 1.58 g (1.66 mmol) of (C₅H₉)₆(CH₂CH)Si₇O₁₂Ti(OBu^{t}) as a white solid (60% yield).

### EXAMPLE 9

### Preparation of Titanium-Modified Silasesquioxanes Using Incompletely Condensed Silasesquioxanes

1 g (2.94 mmol) of Ti(OBu^{t})₄ is added to a solution of 2.7 g (2.70 mmol) of (C₅H₉)₆(CH₂CH)Si₇O₉(OH)₃ in 100 ml of toluene and the reaction mixture is stirred for 30 minutes. The solid is subsequently filtered off, dissolved in toluene and reprecipitated by means of acetonitrile. This gives 1.66 g (1.49 mmol) of (C₇H₁₃)₆(CH₂CH)Si₇O₁₂Ti(Bu^{t}) as a white solid (55% yield).

The disclosure of German application 10060776.4, filed Dec. 7, 2000, the priority of which is claimed herein, is hereby incorporated by reference.

1. An oligomeric silasesquioxane having the formula R₆Si₆O₉ where R is the same or different, and is substituted or unsubstituted, and wherein each R as unsubstituted is selected from the group consisting of alkyl, cycloalkyl other than cyclohexyl, alkenyl, cycloalkenyl, alkynyl, cycloalkynyl, aryl and heteroaryl, and the structure I

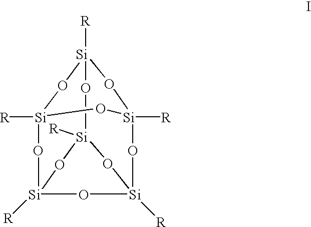

2. The oligomeric silasesquioxane as claimed in claim 1, wherein R is at least one of methyl, ethyl, propyl, butyl, i-butyl, cyclopropyl, cyclobutyl, cyclopentyl, cycloheptyl, cyclooctanyl, cyclononanyl, cyclodecanyl, vinyl, propenyl, monounsaturated or polyunsaturated butenyl, cyclopropenyl, monounsaturated or polyunsaturated cyclobutenyl, monounsaturated or polyunsaturated cyclopentenyl, monounsaturated or polyunsaturated cyclohexenyl, monounsaturated or polyunsaturated cycloheptenyl, monounsaturated or polyunsaturated cyclooctenyl, ethynyl, propynyl, monounsaturated or polyunsaturated butynyl, benzyl, and pyridyl.

3. The oligomeric silasesquioxane as claimed in claim 1, wherein at least one R is substituted.

4. The oligomeric silasesquioxane as claimed in claim 1, wherein at least one R is cyclopentyl or cycloheptyl.

5. The oligomeric silasesquioxane as claimed in claim 1, wherein the Rs are all identical.

6. A process for preparing oligomeric silasesquioxanes having the formula R₆Si₆O₉ where R is the same or different, and is substituted or unsubstituted, and wherein each R as unsubstituted is selected from the group consisting of alkyl, cycloalkyl, alkenyl, cycloalkenyl, alkynyl, cycloalkynyl, aryl and heteroaryl, and the structure I 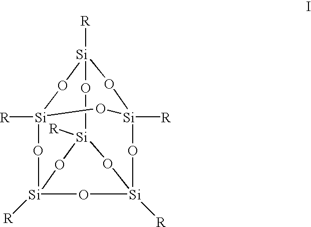
comprising condensation of monomers of the formula RSiX₃, where X is a hydrolyzable group or a group capable of a condensation reaction, wherein the condensation is carried out in solution at a concentration of monomers of greater than 0.2 mol/l.

7. The process as claimed in claim 6, wherein the concentration of monomers in the solution is greater than 0.4 mol/l.

8. The process as claimed in claim 6, wherein the concentration of monomers is from 0.5 mol/l to 2.5 mol/l.

9. The process as claimed in claim 6, wherein X is at least one group selected from the group consisting of —OH, —ONa, —OK, —OR′, —OCOR′, —OSiR′₃, —Cl, —Br, —I and —NR′₂, where R′ is an organic radical or hydrogen.

10. The process as claimed in claim 6, wherein all three groups X are identical in RSiX₃.

11. The process as claimed in claim 6, wherein R is at least one of methyl, ethyl, propyl, butyl, i-butyl, cyclopropyl, cyclobutyl, cyclopentyl, cyclohexyl, cycloheptyl, cyclooctanyl, cyclononanyl, cyclodecanyl, vinyl, propenyl, monounsaturated or polyunsaturated butenyl, cyclopropenyl, monounsaturated or polyunsaturated cyclobutenyl, monounsaturated or polyunsaturated cyclopentenyl, monounsaturated or polyunsaturated cyclohexenyl, monounsaturated or polyunsaturated cycloheptenyl, monounsaturated or polyunsaturated cyclooctenyl, ethynyl, propynyl, monounsaturated or polyunsaturated butynyl, benzyl, and pyridyl.

12. The process as claimed in claim 6, wherein the condensation is carried out in the absence of a catalyst or in the presence of at least one acidic catalyst or at least one basic catalyst.

13. The process as claimed in claim 12, wherein the condensation is carried out in the presence of at least one basic catalyst, wherein the basic catalyst is at least one of KOH, NaOH, (C₂H₅)NOH, C₆H₅CH₂(CH₃)₃NOH, (CH₃)₄NOH and (C₂H₅)₃N.

14. The process as claimed in claim 12, wherein the condensation is carried out in the presence of at least one acidic catalyst, wherein the acidic catalyst is at least one of hydrochloric acid, sulfuric acid, nitric acid, ZnCl₂, AlCl₃, HClO₄ and acetic acid.

15. The process as claimed in claim 6, wherein the condensation is carried out in a solution comprising, as solvent, at least one compound selected from the group consisting of alcohols, ketones, aldehydes, ethers, acids, esters, anhydrides, alkanes, aromatic compounds and nitrites.

16. The process as claimed in claim 6, wherein the condensation is carried out at a temperature of from −20° C. to 300° C.

17. A process comprising incompletely condensing the oligomeric silasesquioxane as claimed in claim 1 to form an incompletely condensed silasesquioxane.

18. An incompletely condensed silasesquioxane of the oligomeric silasesquioxane as claimed in claim 1.

19. A process comprising incompletely condensing the oligomeric silasesquioxane obtained by the process as claimed in claim 6 to form an incompletely condensed silasesquioxane.

20. An incompletely condensed silasesquioxane of the oligomeric silasesquioxane obtained by the process as claimed in claim 19, wherein at least one R is not cyclohexyl.

21. A process comprising metal-modifying the incompletely condensed silasesquioxane as claimed in claim 18 by reacting said incompletely condensed silasesquioxane with a metal compound.

22. A metal-modified incompletely condensed silasesquioxane of the incompletely condensed silasesquioxane as claimed in claim 18.

23. A process comprising metal-modifying the incompletely condensed silasesquioxane obtained by the process as claimed in claim 19 by reacting said incompletely condensed silasesquioxane with a metal compound.

24. A metal-modified incompletely condensed silasesquioxane of the incompletely condensed silasesquioxane obtained by the process as claimed in claim 23, wherein at least one R is not cyclohexyl.

25. An oligomeric silasesquioxane having the formula R^{a}ₘR^{b}ₙR^{c}ₒR^{d}ₚR^{e}_{q}R^{f}ₛSi₆O₉ where m, n, o, p, q and s are each an integer less than or equal to 6, or 0, and m+n+0+p+q+S 6, and where R^{a}, R^{b}, R^{c}, R^{d}, R^{e}, and R^{f}, are the same or different, and are substituted or unsubstituted, and wherein each R^{a}, R^{b}, R^{c}, R^{d}, R^{e}, and R^{f} as unsubstituted is selected from the group consisting of alkyl, cycloalkyl, alkenyl, cycloalkenyl, alkynyl, cycloalkynyl, aryl and heteroaryl, and the structure I 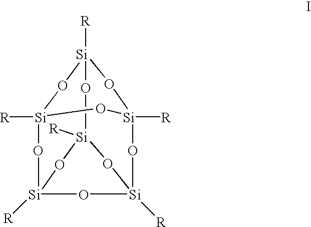
and wherein at least one of R^{a}, R^{b}, R^{c}, R^{d}, R^{e}, and R^{f}, is not cyclohexyl.
